(19) United States
(12) Patent Application Publication
(10) Pub. No.: US 2015/0371745 A1
(43) Pub. Date: Dec. 24, 2015

(54) MAGNETIC CORE POWDER, POWDER MAGNETIC CORE, AND METHOD FOR PRODUCING MAGNETIC CORE POWDER AND POWDER MAGNETIC CORE

(71) Applicants: Hikaru ARAKI, Mie (JP); Norikazu MUNEDA, Mie (JP); Eiichirou SHIMAZU, Mie (JP)

(72) Inventors: Hikaru ARAKI, Mie (JP); Norikazu MUNEDA, Mie (JP); Eiichirou SHIMAZU, Mie (JP)

(73) Assignee: NTN CORPORATION, Osaka (JP)

(21) Appl. No.: 14/764,369

(22) PCT Filed: Feb. 21, 2014
(86) PCT No.: PCT/JP2014/054154

§ 371 Date: Jul. 29, 2015

(30) Foreign Application Priority Data
Mar. 8, 2013 (JP) 2013-046999
Feb. 7, 2014 (JP) 2014-022497

(51) Int. Cl. H01F 1/24; H01F 41/02; H01F 41/00; H01F 3/08

(52) U.S. Cl. CPC H01F 1/24; H01F 3/08; H01F 41/0246; H01F 41/00

(57) ABSTRACT

Provided is a powder (1) for a magnetic core, including: a soft magnetic metal powder (2); an insulating coating (3) for covering a surface of the soft magnetic metal powder (2); and a lubricating coating (4) for covering a surface of the insulating coating (3). The lubricating coating (4) is formed by eliminating a solvent component and causing a lubricating component to adhere to a coated powder (1′) in a lubricant solution (26) supplied into a container (21) in which the coated powder (1′) is being stirred in a floating state, the coated powder being formed by covering the surface of the soft magnetic metal powder (2) with the insulating coating (3).

### TECHNICAL FIELD

The present invention relates to a powder for a magnetic core and a powder magnetic core, and to methods of producing a powder for a magnetic core and a powder magnetic core.

### BACKGROUND ART

As is well known, for example, a power source circuit, which is used by being incorporated into, for example, an electric product and a mechanical product, is mounted with a transformer, a step-up transformer, a rectifier, and the like, which include various coil components (such as a choke coil and a reactor) each formed of a magnetic core and a winding as main parts. In order to respond to a request for low power consumption with respect to the electric product and the mechanical product on the background of increasing consciousness of energy saving in recent years, there is a demand for improvements in magnetic characteristics of the magnetic core to be used frequently in the power source circuit. Further, in recent years, with increasing consciousness of a global warming issue, there has been an increasing demand for a hybrid electric vehicle (HEV), which can suppress consumption of fossil fuel, and an electric vehicle (EV), which does not directly consume fossil fuel. Running performance and the like of the HEV and the EV depend on performance of a motor. Therefore, there is also a demand for improvements in magnetic characteristics of a magnetic core (a stator core or a rotor core) to be incorporated into various motors.

In recent years, as the magnetic core, a powder magnetic core, which has a high degree of freedom of a shape and is easy to respond to a request for miniaturization and a complicated shape, tends to be used frequently. However, the powder magnetic core is a porous body obtained by subjecting a powder for a magnetic core (for example, a powder formed of a soft magnetic metal powder and an insulating coating for covering a surface of the soft magnetic metal powder) to compression molding, and hence the powder magnetic core is in most cases inferior to a laminated magnetic core in which structurally dense magnetic steel plates are laminated, in terms of various strength aspects such as mechanical strength, chipping resistance, and the like. Therefore, for example, in order to apply the powder magnetic core to members having a high rotation speed and a high acceleration and being exposed to vibration constantly, as in motors to be mounted to vehicles such as automobiles and railroad vehicles, it is necessary to enhance various strengths of the powder magnetic core.

In order to enhance various strengths of the powder magnetic core, it is effective to increase the density thereof. As technical means for obtaining a powder magnetic core having a high density, a die lubrication molding method involving subjecting a raw material powder to compression molding in a state in which a powdery lubricant (solid lubricant) adheres to an inner wall surface of a die (cavity-defining surface) (for example, Patent Literature 1), a warm compacting method involving subjecting a raw material powder to compression molding in a state in which a die is heated to a predetermined temperature (for example, Patent Literature 2), and the like have been known. Further, as disclosed in, for example, Patent Literatures 3 and 4, an attempt has also been made to subject a raw material powder to compression molding by using both the die lubrication molding method and the warm compacting method.

### CITATION LIST

Patent Literature 1: JP 3383731 B2
Patent Literature 2: JP 2003-171741 A
Patent Literature 3: JP 2005-72112 A
Patent Literature 4: JP 4770667 B2

### SUMMARY OF INVENTION

### Technical Problem

However, when the die lubrication molding method is adopted, it is necessary to perform treatment for causing a lubricant to adhere to the cavity-defining surface for each shot, and hence a cycle time is prolonged. Further, in the case of adopting the die lubrication molding method so as to obtain a powder magnetic core having a high density, a raw material powder free of a lubricant or a raw material powder containing a small amount of a lubricant (raw material powder substantially formed of a powder for a magnetic core alone) is generally used in most cases. Therefore, large friction is caused between adjacent powders for a magnetic core during compression molding, with the result that an insulating coating is liable to be damaged and the like. Then, when the insulating coating is damaged and the like, it becomes difficult to obtain a powder magnetic core having desired magnetic characteristics. On the other hand, in order to adopt the warm compacting method, a dedicated die apparatus is required, and hence production cost increases significantly.

In view of the above-mentioned circumstances, it is an object of the present invention to enable a powder magnetic core excellent in various strengths such as mechanical strength and chipping resistance, and further excellent in magnetic characteristics, to be produced at low cost.

### Solution to Problem

According to one embodiment of the present invention, as technical means for achieving the above-mentioned object, there is provided a powder for a magnetic core, comprising: a soft magnetic metal powder; an insulating coating for covering a surface of the soft magnetic metal powder; and a lubricating coating for covering a surface of the insulating coating, wherein the lubricating coating is formed by eliminating a solvent component and causing a lubricating component to adhere to a coated powder in a lubricant solution supplied into a container in which the coated powder is being stirred in a floating state, the coated powder being formed by covering the surface of the soft magnetic metal powder with the insulating coating. It should be noted that the term “lubricant solution” as used herein refers to a liquid produced by dissolving (or dispersing) a powdery lubricant (solid lubricant) in an appropriate solvent, the liquid containing a lubricating component and a solvent component.

As described above, the powder for a magnetic core according to the present invention has such a configuration that the surface of the soft magnetic metal powder is covered with the insulating coating, and the surface of the insulating coating is further covered with the lubricating coating (lubricating layer). As long as the powder for a magnetic core has an outermost layer formed of the lubricating coating as described above, even in the case where only the powder is subjected to compression molding, the friction force between the powders and the friction force between the powder and the die inner wall surface can be alleviated. Therefore, a powder magnetic core having a high density can be obtained even without using a mixed powder in which a lubricant is added to (mixed with) the coated powder (compression molding) or adopting the die lubrication molding method in the process of obtaining the powder magnetic core. Specifically, when the powder for a magnetic core of the present invention is subjected to compression molding, a powder magnetic core having a relative density increased to 93% or more, and having sufficiently enhanced magnetic characteristics as well as sufficiently enhanced various strengths such as mechanical strength and chipping resistance can be obtained stably at low cost. It should be noted that the relative density is represented by the following relational expression.

Relative density=(Density of entire powder magnetic core/True density)×100[%]

In addition, in the powder for a magnetic core according to the present invention, the lubricating coating is formed by eliminating the solvent component and causing the lubricating component to adhere to (and solidify on) the surface of the coated powder (insulating coating) in the lubricant solution supplied into the container in which the coated powder is being stirred (circulated) in a floating state. When a lubricating coating is formed in such a mode, a lubricating coating having a uniform thickness can be obtained easily, and further the variation in thickness of a lubricating coating between the powders for a magnetic core can be prevented to the extent possible. Therefore, a powder magnetic core having desired strength and magnetic characteristics can be obtained stably.

In the powder for a magnetic core having the above-mentioned configuration, the lubricating coating may comprise at least one of metal soap or amide wax. That is, the lubricating coating can be obtained as a layered material formed so as to adhere onto a surface of the coated powder by eliminating a solvent component in a lubricant solution produced by dissolving at least one of a lubricant of the metal soap or a lubricant of the amide wax in an appropriate solvent.

In the powder for a magnetic core having the above-mentioned configuration, when the thickness of the lubricating coating is too small, the lubricating coating is liable to be damaged and the like during compression molding of the powder for a magnetic core, and thus there is a risk in that desired lubricating performance may not be exhibited. On the other hand, when the thickness of the lubricating coating is too large, it becomes difficult to subject the powder for a magnetic core to compression molding at a high density, and hence it becomes difficult to obtain a powder magnetic core having desired magnetic characteristics and strength. Therefore, it is preferred that the thickness of the lubricating coating be 50 nm or more and 750 nm or less.

The soft magnetic metal powder for forming the powder for a magnetic core can be used without any problems irrespective of a production method by which the soft magnetic metal powder is produced. Specifically, there may be used any of a reduced powder produced by a reduction method, an atomized powder produced by an atomizing method, and an electrolytic powder produced by an electrolytic method. It should be noted that, of those, an atomized powder, which is excellent in magnetic characteristics, and further has a low coefficient of elasticity and is excellent in plastic deformability (moldability), is desirably used.

In the case where a soft magnetic metal powder having a small particle diameter of less than 30 μm is used as a base material for the powder for a magnetic core, it becomes difficult to subject the powder for a magnetic core to compression molding at a high density (to obtain a powder magnetic core having a high density), and in addition, a hysteresis loss (iron loss) of the powder magnetic core increases. Further, in the case where a soft magnetic metal powder having a large particle diameter of more than 300 μm is used as a base material for the powder for a magnetic core, an eddy-current loss (iron loss) of a powder magnetic core increases. Therefore, it is preferred that the soft magnetic metal powder have a particle diameter of 30 μm or more and 300 μm or less. It should be noted that the term “particle diameter” as used herein refers to a number average particle diameter (the same applies to the following).

The soft magnetic metal powder for forming the powder for a magnetic core may be any one selected from the group of a pure iron (Fe) powder having a purity of 97% or more, a silicon iron (Fe—Si) powder, a permalloy (Fe—Ni) powder, a permendur (Fe—Co) powder, a sendust (Fe—Al—Si) powder, a supermalloy (Fe—Mo—Ni) powder, and the like. Of those, a pure iron powder is particularly preferred. This is because the pure iron powder allows a powder magnetic core having high strength and being excellent in magnetic characteristics to be obtained easily as compared to the other iron-based powders described above.

The powder for a magnetic core according to the present invention has the above-mentioned various features. Therefore, a powder magnetic core formed by heating a compact of the powder for a magnetic core is excellent in various strengths and magnetic characteristics. In particular, a strain accumulated in the soft magnetic metal powder during compression molding or the like can be removed by appropriately adjusting the heating treatment conditions (heating temperature, time, etc.) of the compact, and hence a powder magnetic core excellent in magnetic characteristics can be obtained. It should be noted that the heating temperature can be set to, for example, 300° C. or more.

According to another embodiment of the present invention, as another technical means for achieving the above-mentioned object, there is provided a method of producing a powder for a magnetic core, comprising: a first step of producing a coated powder that is formed by covering a surface of a soft magnetic metal powder with an insulating coating; and a second step of forming a lubricating coating for covering a surface of the coated powder, the second step comprising forming the lubricating coating by eliminating a solvent component and causing a lubricating component to adhere to the surface of the coated powder in a lubricant solution supplied into a container in which the coated powder is being stirred in a floating state.

By adopting the above-mentioned production method, the same action and effect as those of the powder for a magnetic core according to the embodiment of the present invention described above can be effectively exhibited.

When the lubricating coating is formed in the second step, the solvent component contained in the lubricant solution may be eliminated before the lubricant solution is brought into contact with (adheres to) the coated powder. However, in this case, the lubricating coating cannot be caused to adhere to the coated powder with desired fixing strength (adhesion strength), and hence there is an increased risk in that a part or a whole of the lubricating coating may be peeled and the like. Further, the solvent component contained in the lubricant solution may be eliminated after the lubricant solution is brought into contact with (adheres to) the coated powder. However, in this case, the lubricant solution and the coated powder are liable to cohere with each other, which makes it difficult to form a lubricating coating having a uniform thickness. In contrast, when the solvent component contained in the lubricant solution is eliminated concurrently with the contact of the lubricant solution supplied into the container with the coated powder, the above-mentioned trouble can be prevented to the extent possible.

Further, when the method of producing a powder magnetic core comprising the compression molding step of obtaining a compact by subjecting the powder for a magnetic core produced by the above-mentioned production method to compression molding and the heating step of heating the compact is adopted, a powder magnetic core excellent in magnetic characteristics can be obtained stably.

### Advantageous Effects of Invention

As described above, according to the embodiments of the present invention, the powder magnetic core excellent in various strengths such as mechanical strength and chipping resistance, and further excellent in magnetic characteristics can be produced stably at low cost.

### BRIEF DESCRIPTION OF DRAWINGS

FIG. 1 is a schematic sectional view of a powder for a magnetic core according to an embodiment of the present invention.

FIG. 2A is a view for schematically illustrating a part of a first step of producing a coated powder formed by covering a surface of a soft magnetic metal powder with an insulating coating.

FIG. 2B is a schematic sectional view of the coated powder.

FIG. 3 is a view for schematically illustrating a second step of producing the powder for a magnetic core illustrated in FIG. 1.

FIG. 4A is a view for schematically illustrating an initial stage of a compression molding step.

FIG. 4B is a view for schematically illustrating an intermediate stage of the compression molding step.

FIG. 4C is a view for schematically illustrating a part of a compact obtained through the compression molding step.

FIG. 5 is a view for schematically illustrating a part of a powder magnetic core obtained through a heating step.

FIG. 6 is a plan view of a stator core that is an example of a powder magnetic core.

FIG. 7A is a view for schematically illustrating an initial stage of a compression molding step according to another embodiment of the present invention.

FIG. 7B is a view for schematically illustrating an intermediate stage of the compression molding step according to the another embodiment of the present invention.

FIG. 8 is a table for showing test results of a confirmation test.

### DESCRIPTION OF EMBODIMENTS

Now, embodiments of the present invention are described with reference to the drawings.

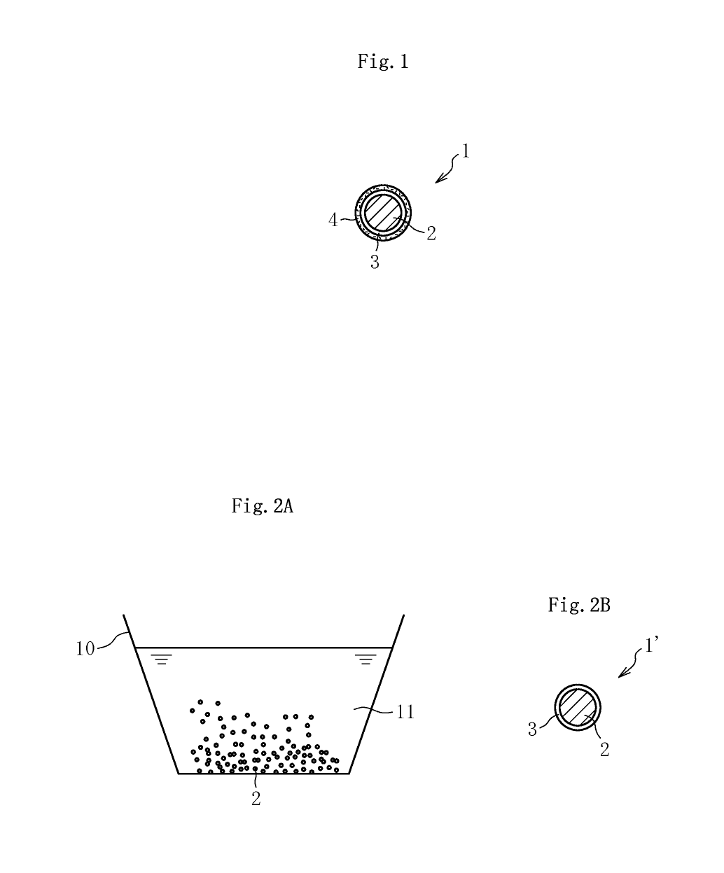

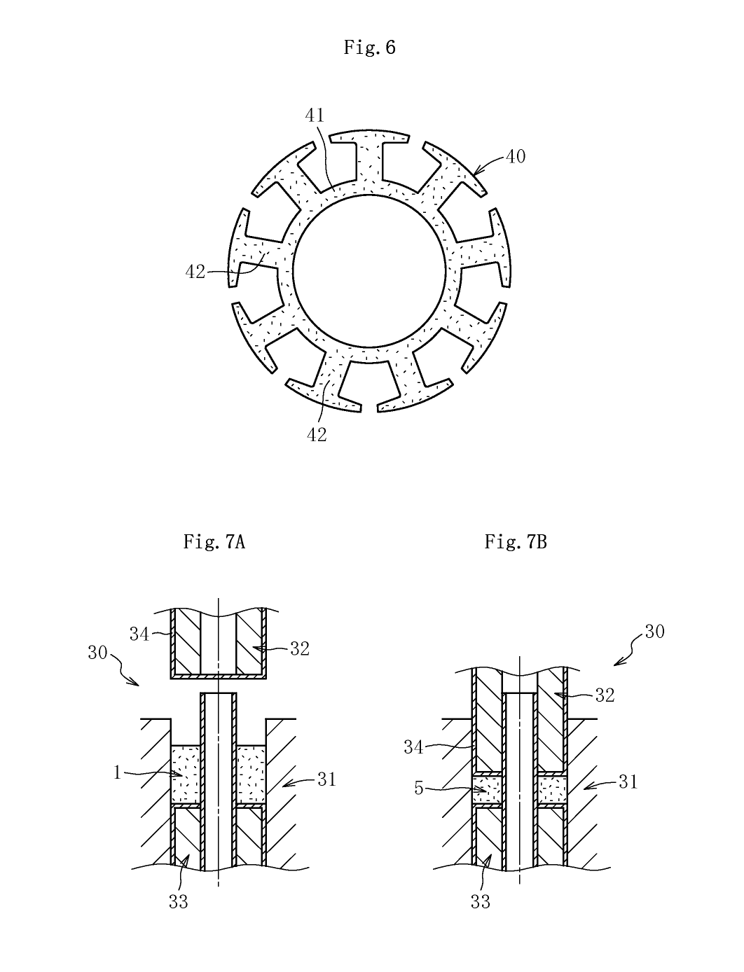

A powder 1 for a magnetic core according to an embodiment of the present invention comprises a soft magnetic metal powder 2, an insulating coating 3 for covering a surface of the soft magnetic metal powder 2, and a lubricating coating 4 for covering a surface of the insulating coating 3, as illustrated in FIG. 1. The powder 1 for a magnetic core is a powder for molding into a powder magnetic core, for example, a stator core 40 (see FIG. 6) to be used, for example, by being incorporated into a stator of a motor, and is produced through a first step of producing a coated powder 1′ formed by covering the surface of the soft magnetic metal powder 2 with the insulating coating 3, and a second step of forming the lubricating coating 4 for covering the surface of the insulating coating 3 (producing the powder 1 for a magnetic core illustrated in FIG. 1). Now, each step is described in detail.

[First Step]

For example, as illustrated in FIG. 2A, the first step involves soaking the soft magnetic metal powder 2 in a solution 11 containing a compound for forming the insulating coating 3 filled into a container 10, and performing drying treatment for removing a liquid component (solvent component) of the solution 11 adhering to the surface of the soft magnetic metal powder 2, thereby obtaining the coated powder 1′ (see FIG. 2B) including the soft magnetic metal powder 2 and the insulating coating 3 for covering the surface of the soft magnetic metal powder 2. It should be noted that, as the thickness of the insulating coating 3 increases, it becomes more difficult to obtain a compact having a high density, and a powder magnetic core excellent in both various strengths such as mechanical strength and chipping resistance and magnetic characteristics (in particular, magnetic permeability). On the other hand, as the thickness of the insulating coating 3 decreases, the magnetic permeability of the powder magnetic core can be enhanced more, but when the thickness of the insulating coating 3 is too small, there is an increased risk in that the insulating coating 3 is broken and the like when the powder 1 for a magnetic core is subjected to compression molding (when molded into a compact). Therefore, the thickness of the insulating coating 3 is preferably 1 nm or more and 500 nm or less, more preferably 1 nm or more and 100 nm or less, still more preferably 1 nm or more and 20 nm or less.

As the soft magnetic metal powder 2, for example, there may be used a pure iron powder having a purity of 97% or more, a silicon iron (Fe—Si) powder, a permalloy (Fe—Ni) powder, a permendur (Fe—Co) powder, a sendust (Fe—Al—Si) powder, and a supermalloy (Fe—Mo—Ni) powder. It should be noted that the pure iron powder is used in this embodiment because the pure iron powder allows a powder magnetic core having high strength and being excellent in magnetic characteristics to be obtained easily as compared to the other iron-based powders described above.

In addition, the soft magnetic metal powder 2 (pure iron powder in this embodiment) can be used without any problems irrespective of a production method by which the soft magnetic metal powder 2 is produced. Specifically, there may be used any of a reduced powder produced by a reduction method, an atomized powder produced by an atomizing method, and an electrolytic powder produced by an electrolytic method. It should be noted that, of those, an atomized powder, which has a relatively high purity, is excellent in removal property of a strain, and further has a low coefficient of elasticity and is excellent in plastic deformability (compression moldability), is preferably used. The atomized powder is roughly classified into a water atomized powder produced by a water atomizing method and a gas atomized powder produced by a gas atomizing method. The water atomized powder has a low coefficient of elasticity and is excellent in plastic deformability as compared to the gas atomized powder, and hence a compact having a high density and a powder magnetic core excellent in various strengths and magnetic characteristics can be obtained easily. Thus, in the case of using the atomized powder as the soft magnetic metal powder 2, the water atomized powder is particularly preferably selected and used.

Even if the particle diameter (number average particle diameter) of the soft magnetic metal powder 2 to be used is too small, or in contrast, even if the particle diameter is too large, it becomes difficult to obtain a compact having a high density and a powder magnetic core excellent in various strengths and magnetic characteristics. Specifically, in the case where the soft magnetic metal powder 2 having a small particle diameter of less than 30 μm is used as a base material for the powder 1 for a magnetic core, it becomes difficult to subject the powder 1 for a magnetic core to compression molding at a high density, and in addition, a hysteresis loss (iron loss) of a powder magnetic core increases. Further, in the case where the soft magnetic metal powder 2 having a large particle diameter of more than 300 μm is used as a base material for the powder 1 for a magnetic core, an eddy-current loss (iron loss) of a powder magnetic core increases. Therefore, the soft magnetic metal powder 2 having a particle diameter of 30 μm or more and 300 μm or less is used.

The insulating coating 3 is preferably formed of a compound that is mutually joined in a solid phase state without being liquefied when a compact formed by subjecting the powder 1 for a magnetic core to compression molding is heated at a recrystallization temperature or more and a melting point or less of the soft magnetic metal powder 2. Specifically, the insulating coating 3 is formed of a compound having a melting point of more than 700° C. and less than 1,600° C. Of the compounds that satisfy such condition, preferred examples thereof may comprise iron oxide (Fe₂O₃), sodium silicate (Na₂SiO₃), potassium sulfate (K₂SO₄), sodium borate (Na₂B₄O₇), potassium carbonate (K₂CO₃), boron phosphate (BPO₄), and iron sulfide (FeS₂). It should be noted that, in addition to the compounds, the insulation coating 3 may also be formed by using: any other oxide such as silicon oxide or tungsten oxide; any other silicate such as aluminum silicate, potassium silicate, or calcium silicate; any other borate such as lithium borate, magnesium borate, or calcium borate; any other carbonate such as lithium carbonate, sodium carbonate, aluminum carbonate, calcium carbonate, or barium carbonate; or any other phosphate typified by iron phosphate or potassium phosphate.

[Second Step]

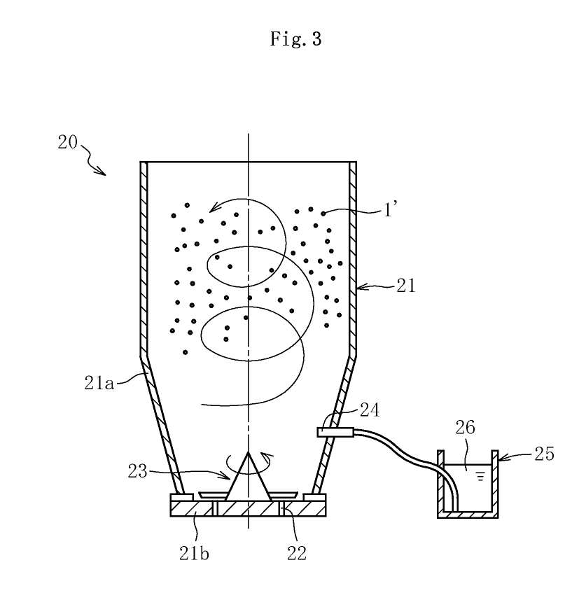

The second step involves forming the lubricating coating 4 for covering the surface of the insulating coating 3 of the coated powder 1′ through use of a tumbling fluidized bed apparatus (also called “tumbling fluidized bed coating apparatus”) 20 as schematically illustrated in FIG. 3. The tumbling fluidized bed apparatus 20 illustrated in FIG. 3 mainly comprises a container 21 having a bottomed cylindrical shape including a tubular portion 21a and a bottom portion 21b, one or a plurality of blast ports 22 opened in a bottom surface in the container, a propeller 23 that is mounted at the center of the bottom portion 21b of the container 21 and rotates with an axial direction of the container 21 being a rotation center, a spray nozzle 24 mounted on the tubular portion 21a of the container 21, and a housing tank 25 for a spray object to be sprayed through an opening of the spray nozzle 24. The lubricating coating 4 is substantially formed as follows.

First, an indefinite number of the powders to be coated 1′ are loaded into the container 21, and a lubricant solution 26 serving as a material for forming the lubricating coating 4 is filled and housed into the housing tank 25. The lubricant solution 26 is a liquid generated by dissolving (or dispersing) a powdery lubricant (solid lubricant) in an appropriate solvent, and contains a lubricating component and a solvent component.

As the lubricant in this case, there may be used a lubricant formed of, for example, metal soap, behenate soap, laurate soap, amide wax, or a thermoplastic resin. As the metal soap, there may be used zinc stearate, calcium stearate, magnesium stearate, iron stearate, aluminum stearate, barium stearate, lithium stearate, sodium stearate, potassium stearate, and the like. As the behenate soap, there may be used calcium behenate, zinc behenate, magnesium behenate, lithium behenate, sodium behenate, silver behenate, and the like. In addition, as the laurate soap, there may be used calcium laurate, zinc laurate, barium laurate, lithium laurate, and the like, and as the amide wax, there may be used stearic acid monoamide, ethylenebisstearamide, oleic acid monoamide, ethylenebisoleamide, erucic acid monoamide, ethylenebiserucamide, lauramide, ethylenebislauramide, palmitamide, behenamide, ethylenebishydroxystearamide, and the like. In addition, polyethylene, polypropylene, and the like may be used as the thermoplastic resin. One kind of the lubricants listed above as examples may be selected and used alone, or two or more kinds thereof may be used in combination. In addition, a lubricant that is completely dissolved in the solvent is preferably selected and used, but a lubricant that is dispersed in the solvent without being completely dissolved may also be used.

In addition, as the solvent, for example, there may be used ethanol, methanol, water, propanol, butanol, acetic acid, formic acid, acetone, dimethylformamide, tetrahydrofuran, acetonitrile, dimethyl sulfoxide, hexane, benzene, toluene, diethyl ether, chloroform, ethyl acetate, methylene chloride, and xylene. One kind of the solvents listed above as examples may be selected and used alone, or two or more kinds thereof may be used in combination. It should be noted that the solvent can also be used by being heated in the case where the lubricant is not dissolved completely at normal temperature.

Then, when the propeller 23 is rotated while air is supplied into the container 21 through the blast ports 22, an airstream as denoted by a helical arrow in FIG. 3 is generated, and along with this, the indefinite number of the powders to be coated 1′ loaded into the container 21 are stirred (circulated) in a floating state. When, with this state kept, the lubricant solution 26 is sprayed into the container 21 in a mist shape through the spray nozzle 24, the lubricant solution 26 adheres to each surface of the powders to be coated 1′ that are being circulated in a floating state in the container 21. In this embodiment, the lubricant solution 26 is sprayed through the spray nozzle 24 under a state in which the supply amount of air, the temperature of air, the rotation speed of the propeller 23, the concentration of the lubricant solution 26, and the like are adjusted so that the solvent component contained in the lubricant solution 26 is lost concurrently (substantially concurrently) with the adhesion of the lubricant solution 26 sprayed into the container 21 to each surface of the powders to be coated 1′. Therefore, when the lubricant solution 26 sprayed into the container 21 adheres to each surface of the powders to be coated 1′, the lubricating coating 4 for covering the surface of the coated powder 1′ with the lubricating component contained in the lubricant solution 26 is formed, that is, the powder 1 for a magnetic core (see FIG. 1) formed of the soft magnetic metal powder 2, the insulating coating 3 for covering the surface of the soft magnetic metal powder 2, and the lubricating coating 4 for covering the surface of the insulating coating 3 is formed. In the case where the lubricating coating 4 is formed in the above-mentioned embodiment, the lubricating coating 4 having a uniform thickness can be obtained easily, and further the variation in thickness of the lubricating coating 4 between the powders 1 for a magnetic core can be prevented to the extent possible. Therefore, a powder magnetic core having desired magnetic characteristics and strength can be produced stably.

It should be noted that the thickness of the lubricating coating 4 can be adjusted at a nano-order level when the concentration, spray amount, spray time (operation time of the tumbling fluidized bed apparatus 20), and the like of the lubricant solution 26 are adjusted. In this case, the above-mentioned various conditions are adjusted and set so that the thickness of the lubricating coating 4 becomes 50 nm or more and 750 nm or less. The thickness of the lubricating coating 4 is set within the above-mentioned range for the following reason. In the case where the thickness of the lubricating coating 4 forming the powder 1 for a magnetic core illustrated in FIG. 1 is too small (in the case where the thickness is less than 50 nm), when the powder 1 for a magnetic core is subjected to compression molding, there is an increased risk in that desired lubricating performance may not be exhibited. On the other hand, as the thickness of the lubricating coating 4 increases, the lubricating performance during compression molding is enhanced more. However, in the case where the thickness of the lubricating coating 4 is too large (in the case where the thickness is more than 750 nm), large cost is required for forming the lubricating coating 4. In addition, depending on the conditions of heating treatment (described later in detail) to be performed in the process of obtaining a powder magnetic core, the lubricating coating 4 is lost to form a hole, and consequently, it becomes difficult to obtain a powder magnetic core having high strength and being excellent in magnetic characteristics.

The powder 1 for a magnetic core obtained as described above is used as a material for molding a powder magnetic core (for example, the stator core 40 as illustrated in FIG. 6), as described above. In the case of using the powder 1 for a magnetic core, a powder magnetic core can be produced, for example, through a compression molding step and a heating step successively. Now, embodiments of the compression molding step and the heating step are described in detail.

[Compression Molding Step]

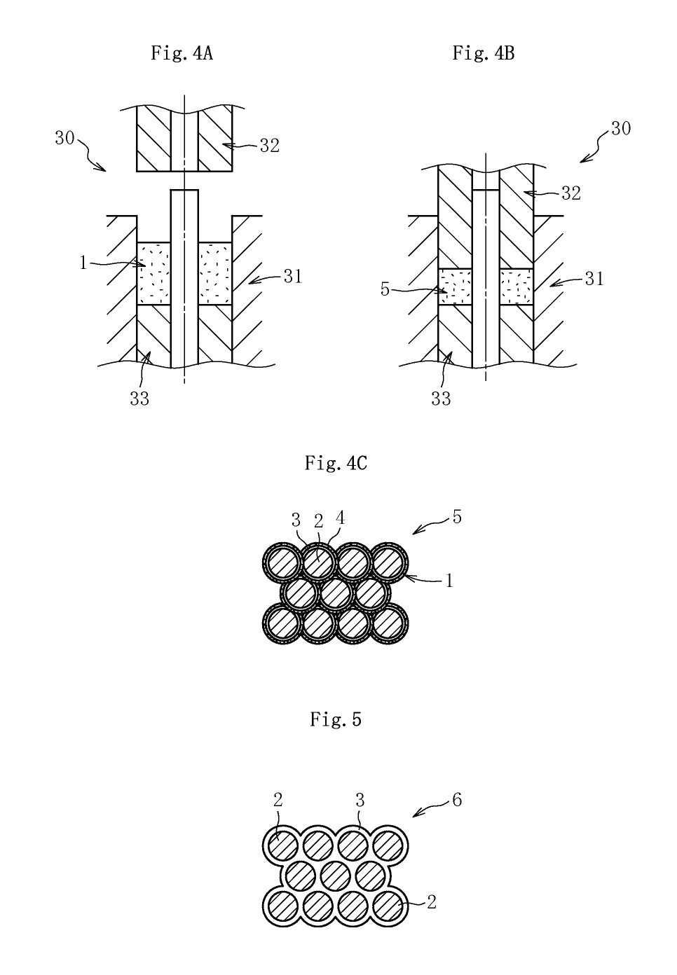

As schematically illustrated in FIG. 4A and FIG. 4B, the compression molding step is a step of obtaining a compact 5 having a substantially completed shape (shape approximate to a powder magnetic core) by subjecting a raw material powder to compression molding through use of a molding die 30 including a die 31, upper and lower punches 32 and 33, and a core arranged coaxially. In this embodiment, the powder 1 for a magnetic core including the lubricating coating 4 as an outermost layer is used. Therefore, the raw material powder is not mixed with a powdery lubricant, and the powder 1 for a magnetic core produced through the above-mentioned steps alone is used as the raw material powder. Further, treatment for causing a lubricant to adhere to an inner wall surface of the molding die 30 (cavity-defining surface) is not performed every time the raw material powder (powder 1 for a magnetic core) is subjected to compression molding. Further, the molding die 30 does not have a structure that may heat the die 31 and the upper and lower punches 32 and 33.

In the above-mentioned configuration, as illustrated in FIG. 4A and FIG. 4B, the powder 1 for a magnetic core is filled into the cavity defined by the die 31 and the lower punch 33, and then the powder 1 for a magnetic core is subjected to compression molding by relatively moving the upper punch 32 so as to be close to the lower punch 33. The molding pressure is set to a pressure at which the contact area between the powders 1 for a magnetic core adjacent to each other can be increased, for example, 600 MPa or more, more preferably 800 MPa or more. Thus, as illustrated in FIG. 4C, the compact 5 having a high density in which the powders 1 for a magnetic core are in strong contact with each other is obtained. It should be noted that, in the case where the molding pressure is too high (for example, in the case where the molding pressure is more than 2,000 MPa), a problem such as a decrease in durability life of the molding die 30 is liable to occur. Thus, it is desired that the molding pressure be set to 600 MPa or more and 2,000 MPa or less.

[Heating Step]

In the heating step, heating treatment (annealing treatment) for heating the compact 5 in an atmosphere of an inert gas such as nitrogen gas or under a vacuum at a predetermined temperature or more is performed. The heating temperature of the compact 5 is set to, for example, 300° C. or more, preferably 500° C. or more. With this, a powder magnetic core from which a strain (crystal strain) accumulated in the soft magnetic metal powder 2 has been appropriately removed is obtained through the compression molding step and the like. It should be noted that, in order to remove the strain accumulated in the soft magnetic metal powder 2 substantially completely, it is sufficient that the compact 5 be heated at a recrystallization temperature or more and a melting point or less of the soft magnetic metal powder 2. In the case of using a pure iron powder as the soft magnetic metal powder 2 as in this embodiment, it is sufficient that the compact 5 be heated at 700° C. or more. Even when the compact 5 is heated at such high temperature, the situation in which the insulating coating 3 is damaged, decomposed, peeled, or the like can be prevented to the extent possible because the insulating coating 3 is formed of a compound having a melting point of more than 700° C. in this embodiment.

When the compact 5 is heated in the above-mentioned embodiment, the lubricating coating 4 formed on the outermost layer of each powder 1 for a magnetic core forming the compact 5 is lost, and hence, in a powder magnetic core, a hole is formed in each portion in which the lubricating coating 4 has been located in a stage of the compact 5. It should be noted that the thickness of the lubricating coating 4 is set to at most 750 nm, which is a numerical value sufficiently smaller than the particle diameter of the soft magnetic metal powder 2 to be used. Therefore, even when the hole is formed in the above-mentioned embodiment, the situation in which the density of the powder magnetic core is significantly decreased can be prevented to the extent possible. Rather, the compact 5 is obtained by subjecting the powder 1 for a magnetic core having the lubricating coating 4 formed on the outermost layer to compression molding, and thus the friction force between the powders and the friction force between the powder and the inner wall surface of the die 30 can be both alleviated even in the case where only the powder 1 for a magnetic core is subjected to compression molding in the compression molding step. Therefore, as compared to the case of subjecting a mixed powder obtained by adding (mixing) a lubricant to the coated powder 1′ to compression molding or the case of adopting the die lubrication molding method disclosed in Patent Literature 1 or the like, the compact 5 having a high density and the powder magnetic core can be obtained stably at low cost. Accordingly, a powder magnetic core having a relative density increased to 93% or more, and having sufficiently enhanced magnetic characteristics as well as sufficiently enhanced various strengths such as mechanical strength and chipping resistance can be obtained stably at low cost.

In terms of the strength aspect, specifically, a powder magnetic core can be obtained in which the radial crushing strength is 50 MPa or more, and the rattler measured value, which is an indicator of chipping resistance, is less than 0.75%. Further, in terms of the magnetic characteristics, specifically, a powder magnetic core can be obtained in which the magnetic flux density is 1.5 T or more and the maximum magnetic permeability is 300 or more in an environment of a DC magnetic field of 10,000 A/m, and further the iron loss is less than 140 W/kg under the conditions of a frequency of 1,000 Hz and a magnetic flux density of 11 in an AC magnetic field.

It should be noted that, in the case where the compact is heated at 700° C. or more, a powder magnetic core 6 can be obtained in which a strain accumulated in the soft magnetic metal powder 2 has been removed, and concurrently the insulating coatings 3 for covering the surface of the soft magnetic metal powder 2 have been joined to each other in a solid phase state without being liquefied (see FIG. 6). The powder magnetic core 6 thus obtained has higher strength and is more excellent in magnetic characteristics. The solid phase joined state of the insulating coatings 3 is obtained by solid phase sintering or a dehydration condensation reaction, and whether the insulating coatings 3 are joined to each other by solid phase sintering or dehydration condensation varies depending on the kind of the compound used for forming the insulating coatings 3.

The powder magnetic core obtained by using the powder 1 for a magnetic core according to the present invention has sufficiently enhanced various strengths required of the powder magnetic core such as mechanical strength and chipping resistance in addition to the magnetic characteristics, as described above. Therefore, the powder magnetic core can be preferably used as motors for vehicles having a high rotation speed and a high acceleration and being exposed to vibration constantly, such as automobiles and railroad vehicles, and as magnetic cores of components for power source circuits, such as a choke coil, a power inductor, and a reactor. Specifically, the powder magnetic core obtained by using the powder 1 for a magnetic core according to the present invention can be used as the stator core 40 as illustrated in FIG. 6. The stator core 40 illustrated in FIG. 6 is used by being integrated, for example, with a base member forming a stationary side of various motors, and includes a cylindrical portion 41 having an attachment surface with respect to the base member and a plurality of protrusions 42 extending radially from the cylindrical portion 41 to the outside in a radial direction, a coil (not shown) being wound around the outer circumference of the protrusions 42. The powder magnetic core has a high degree of freedom of a shape, and hence not only the stator core 40 as illustrated in FIG. 6 but also a core having a more complicated shape can be easily mass-produced.

In the foregoing, the powder 1 for a magnetic core according to the embodiment of the present invention and the production method therefor, and the powder magnetic core and the production method therefor have been described. However, the powder 1 for a magnetic core and the production method therefor, and the powder magnetic core and the production method therefor can be appropriately modified within the range not departing from the spirit of the present invention.

For example, the heating step performed in the process of producing the powder magnetic core may be performed as necessary, and may be omitted.

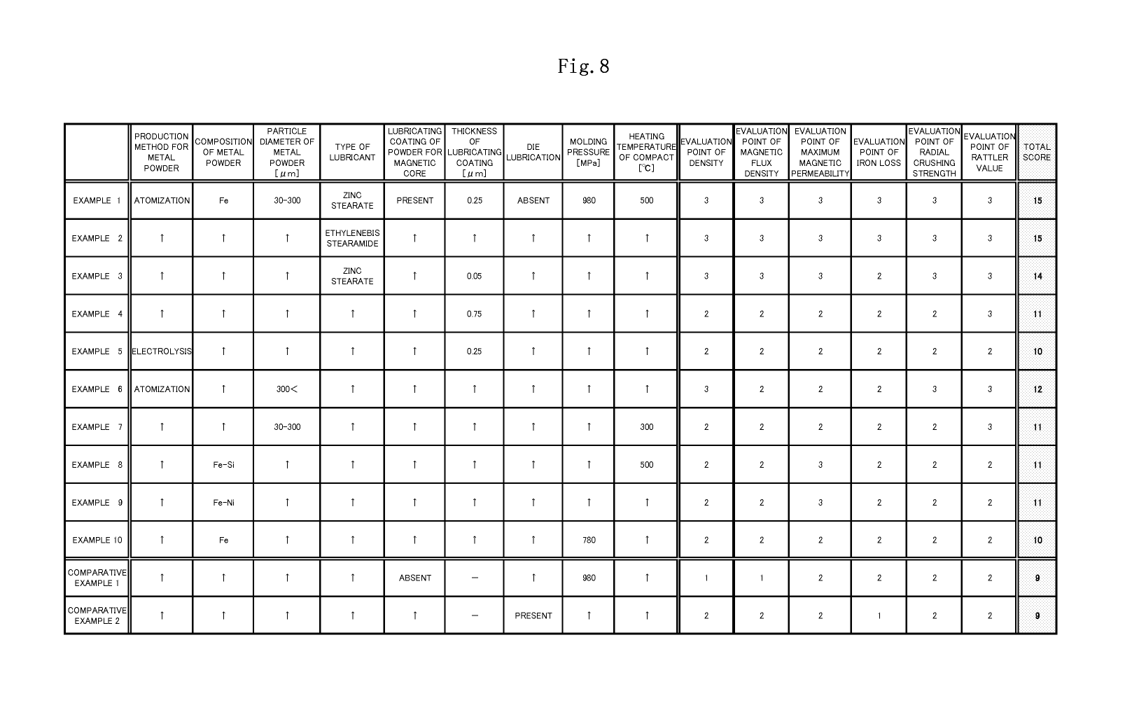

Further, during the compression molding of the powder 1 for a magnetic core, for example, the molding die 30 can also be used in which a hard film 34 having a sliding property is formed on a lower end surface and an outer peripheral surface of the upper punch 32, on an upper end surface and an outer peripheral surface of the lower punch 33, and on an outer peripheral surface of the core (see FIG. 7A and FIG. 7B). With this, a friction force between the molding die 30 and the powder 1 for a magnetic core can be further alleviated, and hence the compact 5 having a higher density can be obtained easily. Further, the friction force between the upper punch 32, and the die 31 and the core during driving of the molding die 30, and the friction force between the lower punch 33, and the die 31 and the core can be alleviated. Therefore, the durability life of the molding die 30 can be extended, and the production cost of the powder magnetic core can be reduced.

As the hard film 34 having a sliding property, for example, there may be adopted a DLC film, a TiAlN film, a CrN film, a TiN film, a TiCN film, an AlCrSiN film, a VN film, a CrAlSiN film, a TiC film, a CrAlN film, a VC film, and a WC film. One of these films may be used as a single layer, or a plurality thereof may be used as a laminate. The thickness of the hard film 34 is not particularly limited, and may be, for example, 0.1 μm or more and 3 μm or less.

### EXAMPLES

In order to verify the usefulness of the present invention, ring-shaped test pieces corresponding to the powder magnetic cores produced through use of the powder for a magnetic core according to the present invention (Examples 1 to 10) and ring-shaped test pieces corresponding to powder magnetic cores produced through use of a powder for a magnetic core not having the configuration of the present invention (Comparative Examples 1 and 2) were each subjected to confirmation tests for calculating and measuring the following evaluation items: (1) density; (2) magnetic flux density; (3) maximum magnetic permeability; (4) iron loss; (5) radial crushing strength; and (6) rattler value. The evaluation for each of the items (1) to (6) was performed on a three-point scale, and an evaluation point “1 point” means that there is a high risk in that a practical problem may occur. In addition, the performance of each ring-shaped test piece was evaluated by a total value (total score) of evaluation points of the items (2) to (6). Hereinafter, first, methods for confirmation of the evaluation items (1) to (6) and evaluation points thereof are described in detail.

(1) Density

### [Confirmation Method]

The size and weight of each ring-shaped test piece were measured, and the density thereof was calculated from the measurement results. The following evaluation points were given to the ring-shaped test piece in accordance with the calculated value.

### [Evaluation Point]

3 points: 7.5 g/cm³ or more

2 points: 7.3 g/cm³ or more and less than 7.5 g/cm³

1 point: less than 7.3 g/cm³

(2) Magnetic Flux Density

### [Confirmation Method]

Measurement was performed with a DC B—H measurement unit (SK-110 type manufacturedbyMetron Inc.). The magnetic flux density [T] at a magnetic field of 10,000 A/m was calculated. The following evaluation points were given in accordance with the calculated value.

### [Evaluation Point]

3 points: 1.6 T or more

2 points: 1.5 T or more and less than 1.6 T

1 point: less than 1.5 T

(3) Maximum Magnetic Permeability

### [Confirmation Method]

The maximum magnetic permeability at a magnetic field of 10,000 A/m was measured with the same DC B-H measurement unit as that described above. The following evaluation points were given in accordance with the measured value.

### [Evaluation Point]

3 points: 500 or more

2 points: 300 or more and less than 500

1 point: less than 300

(4) Iron Loss

### [Confirmation Method]

The iron loss [W/kg] at a frequency of 1,000 Hz was measured with an AC B-H measurement unit (B-H analyzer SY-8218 manufactured by Iwatsu Test Instruments Corporation). The following evaluation points were given in accordance with the measured value.

### [Evaluation Point]

3 points: less than 110 W/kg

2 points: 110 W/kg or more and less than 140 W/kg

1 point: 140 W/kg or more

(5) Radial Crushing Strength

### [Confirmation Method]

A compression force (compression speed: 1.0 mm/min) in a reduced diameter direction was applied to an outer circumferential surface of each ring-shaped test piece through use of a precision universal tester Autograph manufactured by Shimadzu Corporation, and the compression force divided by a broken cross-sectional area was defined as radial crushing strength [MPa]. The following evaluation points were given in accordance with the calculated value.

### [Evaluation Point]

3 points: 50 MPa or more

2 points: 25 MPa or more and less than 50 MPa

1 point: less than 25 MPa

(6) Rattler Value

### [Confirmation Method]

Compliant with “Rattler value measurement method for metal compact” stipulated under the specification JPMA P11-1992 of Japan Powder Metallurgy Association. Specifically, a ring-shaped test piece loaded into an activity wheel of a rattler measurement unit was rotated 1,000 times, and thereafter, the weight reduction ratio [%] of the ring-shaped test piece was calculated as a rattler value as an indicator of chipping resistance. The following evaluation points were given in accordance with the calculated value.

### [Evaluation Point]

3 points: less than 0.05%

2 points: 0.05% or more and less than 0.75%

1 point: 0.75% or more

Next, a method of producing ring-shaped test piece according to Examples 1 to 10 is described.

### Example 1

A surface of an atomized iron powder having a particle diameter (number average particle diameter) of from 30 μm to 300 μm obtained by classifying an atomized iron powder manufactured by Wako Pure Chemical Industries, Ltd. was covered with an iron phosphate coating serving as an insulating coating to obtain a coated powder. 3 kg of the coated powder was loaded into a container of a tumbling fluidized bed coating apparatus MP-01 manufactured by Powrex Corp., and an ethanol solution of 3 vol % zinc stearate manufactured by NOF Corporation was prepared as a lubricant solution. Then, the tumbling fluidized bed coating apparatus was operated. After it was confirmed that the coated powder was being stirred in a floating state in the container, the lubricant solution was sprayed into the container in a mist shape. The operation conditions (amount of blast, blast temperature, etc.) of the tumbling fluidized bed coating apparatus were adjusted so that a solvent component of the lubricant solution was lost concurrently with the adhesion of the lubricant solution sprayed into the container in a mist shape to the coated powder. The tumbling fluidized bed apparatus was operated for 30 minutes to obtain a powder for a magnetic core in which the surface of the coated powder was covered with a lubricating coating having a thickness of 0.25 μm (250 nm).

Then, the powder for a magnetic core filled into a cavity of a molding die (without performing the adhesion of a lubricant to a cavity-defining surface and the heating of the die) was compressed at a molding pressure of 980 MPa to obtain a ring-shaped compact having an outer diameter, an inner diameter, and a thickness of 20 mm, 13 mm, and 6 mm, respectively. Finally, the ring-shaped compact was heated at 500° C. for 0.5 hr to obtain a ring-shaped test piece of Example 1.

### Example 2

A ring-shaped test piece of Example 2 was obtained by the same procedure as that of the case of obtaining the ring-shaped test piece according to Example 1 except that an ethanol solution of 3 vol % of ALFLOW H-50-TF (ethylenebisstearamide) manufactured by NOF Corporation was used as the lubricant solution to be used for forming a lubricating coating.

### Example 3

A ring-shaped test piece of Example 3 was obtained by the same procedure as that of the case of obtaining the ring-shaped test piece according to Example 1 except that the operation time of the tumbling fluidized bed apparatus was set to 5 minutes, and the thickness of the lubricating coating was set to 0.05 μm (50 nm).

### Example 4

A ring-shaped test piece of Example 4 was obtained by the same procedure as that of the case of obtaining the ring-shaped test piece according to Example 1 except that the operation time of the tumbling fluidized bed apparatus was set to 90 minutes, and the thickness of the lubricating coating was set to 0.75 μm (750 nm).

### Example 5

A ring-shaped test piece of Example 5 was obtained by the same procedure as that of the case of obtaining the test piece according to Example 1 except that an electrolytic iron powder manufactured by Wako Pure Chemical Industries, Ltd. was used as a soft magnetic metal powder.

### Example 6

A ring-shaped test piece of Example 6 was obtained by the same procedure as that of the case of obtaining the ring-shaped test piece according to Example 1 except that an atomized iron powder having a number average particle size of 300 μm or more was used as a soft magnetic metal powder.

### Example 7

A ring-shaped test piece of Example 7 was obtained by the same procedure as that of Example 1 except that the heating conditions of the ring-shaped compact were set to 300° C. for 1 hr.

### Example 8

A ring-shaped test piece of Example 8 was obtained by the same procedure as that of Example 1 except that an atomized ferrosilicon powder having a particle diameter of from 30 μm to 300 μm obtained by classifying an atomized powder of ferrosilicon (Fe—Si) manufactured by Sanyo Special Steel Co., Ltd. was used as a soft magnetic metal powder.

### Example 9

A ring-shaped test piece of Example 9 was obtained by the same procedure as that of Example 1 except that an atomized permalloy powder having a particle diameter of from 30 μm to 300 μm obtained by classifying an atomized powder of permalloy (Fe—Ni) manufactured by Sanyo Special Steel Co., Ltd. was used as a soft magnetic metal powder.

### Example 10

A ring-shaped test piece of Example 10 was obtained by the same procedure as that of Example 1 except that the powder for a magnetic core was compressed at a molding pressure of 780 MPa.

Finally, a method of producing a ring-shaped test piece according to Comparative Examples 1 and 2 is described.

### Comparative Example 1

A coated powder obtained in the same way as in Example 1 and zinc stearate manufactured by NOF Corporation were mixed with a V-shaped mixer to generate a mixed powder containing 2 vol % of zinc stearate. Then, the mixed powder filled into a molding die (without performing the adhesion of a lubricant to a die inner wall surface and the heating of the die) was compressed at a molding pressure of 980 MPa to obtain a ring-shaped compact having an outer diameter, an inner diameter, and a thickness of 20 mm, 13 mm, and 6 mm, respectively. Finally, the ring-shaped compact was heated at 500° C. for 0.5 hr to obtain a ring-shaped test piece of Comparative Example 1.

### Comparative Example 2

A ring-shaped compact was obtained in the same way as in Comparative Example 1 under the condition that a lubricant was caused to adhere to an inner wall surface of the molding die. Then, the ring-shaped compact was heated at 500° C. for 0.5 hr to obtain a ring-shaped test piece of Comparative Example 2 in the same way as in Comparative Example 1.

Evaluation points of (1) density; (2) magnetic flux density; (3) maximum magnetic permeability; (4) iron loss; (5) radial crushing strength; and (6) rattler value, and total values (total scores) of the evaluation points of the evaluation items (2) to (6) in each of Examples 1 to 10 and Comparative Examples 1 and 2 described above are shown in FIG. 8. As apparent from FIG. 8, there was no evaluation item in which any of Examples 1 to 10 was inferior to Comparative Examples 1 and 2 in terms of evaluation points, and as a result, the total score in any of Examples 1 to 10 was higher than those of Comparative Examples 1 and 2. Further, in Examples 1 to 10, there was no evaluation point “1 point” in the evaluation items (1) to (6), and thus it was confirmed that there was no practical problem. In contrast, in Comparative Examples 1 and 2, there were two evaluation items and one evaluation item in which the evaluation point was “1 point”, respectively, and thus it is considered that there is a practical problem. Thus, it is understood that the present invention is useful for obtaining a powder magnetic core excellent in both strength and magnetic characteristics. Now, this understanding is considered in more detail.

The reason that the evaluation point of the density in Comparative Example 1 was “1 point” is considered as follows: the ring-shaped compact was obtained by subjecting the mixed powder generated through use of the V-shaped mixer to compression molding. That is, a lubricant is unevenly distributed inevitably in the mixed powder generated through use of the V-shaped mixer. Therefore, it is considered that there were a large number of portions in which the lubricant was not located during compression molding, and the friction was not able to be suppressed, with the result that the density decreased. Further, it is considered that in a portion in which a bulky lubricant was located, a large hole was formed along with heat treatment, with the result that the evaluation point of the magnetic flux density, in particular, among the magnetic characteristics, was “1 point”. The reason that the evaluation of the iron loss was “1 point” in Comparative Example 2 is considered as follows: the friction force between the powders during compression molding was large, with the result that the ring-shaped compact was not able to be molded at a high density, and further the insulating coating was broken along with the friction.

On the other hand, of Examples 1 to 10, particularly in Examples 1 to 3, the total score was high. The reasons for this are considered as follows: the ring-shaped compact (test piece) was produced through use of the powder for a magnetic core in which the coated powder obtained by covering the surface of the soft magnetic metal powder with the insulating coating was further covered with the lubricating coating; the atomized iron powder was used as the soft magnetic metal powder, and the particle diameter thereof was appropriate; the compression molding condition (molding pressure) of the powder for a magnetic core was appropriate; the heating treatment conditions of the ring-shaped compact were appropriate; and the like.

It is considered that the ring-shaped test piece of Example 4 was produced through use of the powder for a magnetic core including the lubricating coating having a thickness larger than those of the other Examples, and hence the density was lower than those of Examples 1 to 3, in particular, with the result that the total score was lower those that of Examples 1 to 3. However, the evaluation point was “2 points” or more in any of the evaluation items, and hence there is no practical problem. Further, it is considered that the electrolytic iron powder was used as the soft magnetic metal powder in Example 5, and hence the total score was lower than those of the other Examples produced through use of the atomized iron powder. However, the evaluation point was “2 points” or more in any of the evaluation items, and hence there is no practical problem. In Example 6, the iron powder having a particle diameter of 100 μm or more was used, and hence Example 6 was inferior to Examples 1 to 3 in terms of magnetic characteristics. However, the evaluation point was “2 points” or more in any of the evaluation items, and hence there is no practical problem.

It is considered that, in Example 7, the heating temperature of the ring-shaped compact was set to be lower than those of the other Examples, and hence a strain accumulated in the metal powder was not able to be removed sufficiently, with the result that Example 7 was inferior to Examples 1 to 3 in terms of magnetic characteristics. However, the evaluation point was “2 points” or more in any of the evaluation items, and hence there is no practical problem. It is considered that, in Examples 8 and 9, the ferrosilicon (Fe—Si) powder and the permalloy (Fe—Ni) powder inferior to the iron powder in terms of plastic deformability (moldability) were respectively used as the soft magnetic metal powder, and hence such high-density molding as that in each of Examples 1 to 3 was not able to be performed, with the result that the evaluation points were lower than those of Examples 1 to 3 in both magnetic characteristics and strength. However, the evaluation point was “2 points” or more in any of the evaluation items, and hence there is no practical problem. It is considered that, in Example 10, the molding pressure for molding the ring-shaped compact was lower than those of the other Examples, and hence such high-density molding as that in each of Examples 1 to 3 was not able to be performed, with the result that the evaluation points were lower than those of Examples 1 to 3 in both magnetic characteristics and strength. However, the evaluation point was “2 points” or more in any of the evaluation items, and hence there is no practical problem.

Based on the above-mentioned confirmation test results, it can be said that the present invention is extremely useful in that the present invention enables a powder magnetic core excellent in various strengths such as mechanical strength and chipping resistance and further in magnetic characteristics to be produced stably at low cost.

### REFERENCE SIGNS LIST

1 powder for a magnetic core
1′ coated powder
2 soft magnetic metal powder
3 insulating coating
4 lubricating coating
5 compact
6 powder magnetic core
20 tumbling fluidized bed apparatus
40 stator core

1. A powder for a magnetic core, comprising:
a soft magnetic metal powder;
an insulating coating for covering a surface of the soft magnetic metal powder; and
a lubricating coating for covering a surface of the insulating coating,
wherein the lubricating coating is formed by eliminating a solvent component and causing a lubricating component to adhere to a coated powder in a lubricant solution supplied into a container in which the coated powder is being stirred in a floating state, the coated powder being formed by covering the surface of the soft magnetic metal powder with the insulating coating.

2. The powder for a magnetic core according to claim 1, wherein the lubricating coating comprises at least one of metal soap or amide wax.

3. The powder for a magnetic core according to claim 1, wherein the lubricating coating has a thickness of 50 nm or more and 750 nm or less.

4. The powder for a magnetic core according to claim 1, wherein the soft magnetic metal powder comprises an atomized metal powder.

5. The powder for a magnetic core according to claim 1, wherein the soft magnetic metal powder has a particle diameter of 30 μm or more and 300 μm or less.

6. The powder for a magnetic core according to claim 1, wherein the soft magnetic metal powder comprises pure iron powder having a purity of 97% or more.

7. A powder magnetic core, which is formed by heating a compact of the powder for a magnetic core of claim 1.

8. A method of producing a powder for a magnetic core, comprising:
a first step of producing a coated powder formed by covering a surface of a soft magnetic metal powder with an insulating coating; and
a second step of forming a lubricating coating for covering a surface of the coated powder,
the second step comprising forming the lubricating coating by eliminating a solvent component and causing a lubricating component to adhere to the surface of the coated powder in a lubricant solution supplied into a container in which the coated powder is being stirred in a floating state.

9. The method of producing a powder for a magnetic core according to claim 8, wherein the second step comprises eliminating the solvent component contained in the lubricant solution concurrently with a contact of the lubricant solution supplied into the container with the coated powder.

10. A method of producing a powder magnetic core, comprising:
a compression molding step of obtaining a compact by subjecting a powder for a magnetic core produced by the method of producing a powder for a magnetic core of claim 8 to compression molding; and
a heating step of heating the compact.
